(19) United States
(12) Patent Application Publication
(10) Pub. No.: US 2003/0040306 A1
(43) Pub. Date: Feb. 27, 2003

(54) Wireless communication system

(76) Inventors: Hanma Kentaro, Tokyo (JP); Yoshiyuki Ishii, Tokyo (JP); Akihiro Muraishi, Tokyo (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/182,501

(22) PCT Filed: Oct. 29, 2001
(86) PCT No.: PCT/JP01/09473

(30) Foreign Application Priority Data
Aug. 23, 2001 (JP) 2001-252419

(51) Int. Cl. H04B 1/00; H04B 7/00; H04Q 7/20; H04B 7/005; H04B 7/01; H04B 7/015; H04B 15/00; H04M 1/00; H04B 1/38

(52) U.S. Cl. 455/422; 455/502; 455/68; 455/561

(57) ABSTRACT

A first base station (2k) is connected to a communication line (L1), and performs wireless communication on control information with a terminal station (1) via a control channel. Moreover, a second base station (3k) corresponding to the first base station (2k) is connected to a communication line (L2) and performs wireless communication on data with the terminal station (1) via a communication channel based on the control information from the first base station (2k).

### TECHNICAL FIELD

The present invention relates to a wireless communication system, a base station, and a wireless communication method, for providing a wireless communication service to a terminal station, and to the terminal station.

### BACKGROUND ART

In an existing wireless communication system such as a car phone system, a portable phone system, PHS (Personal Handyphone System), or FWA (Fixed Wireless Access), there is an upper limit in terms of design to each of transmission capacities of an uplink and a downlink, and there is a limit to a capacity of communication with all terminal stations or all terminal stations in one cell.

Meanwhile, with the advance of electronic equipment, the throughput of electronic equipment is increasing day by day, and hence processable data quantity also increases, whereby a demand for larger communication capacity in the communication system is rising.

In order to increase communication capacity, however it is necessary to construct a totally new wireless communication system or change specifications of a base station and a terminal station used in the existing communication system, which costs a great deal.

Hence, the present invention is made in view of the aforementioned problem, and its object is to obtain a wireless communication system and a wireless communication method capable of increasing communication capacity at a low cost while making use of facilities of the existing communication system, and a base station and a terminal station used in the wireless communication system.

### DISCLOSURE OF THE INVENTION

A wireless communication system of the present invention comprises: a first base station, connected to a terminal station via a first wireless communication line, for performing wireless communication on control information with the terminal station via a control channel; and a second base station, connected to the terminal station via a second wireless communication line, for performing wireless communication on data with the terminal station via a communication channel based on the control information.

This enables increasing communication capacity at a low cost while making use of facilities of an existing communication system.

Moreover, in a wireless communication system of the present invention, in addition to the wireless communication system of the aforementioned invention, the first base station transmits synchronous control information on wireless communication to the second base station via the control channel, and the second base station receives the synchronous control information via the control channel of the first base station, and based on the received synchronous control information, performs wireless communication with the terminal station in synchronization with wireless communication of the first base station.

Hence, it is simplified that the first base station controls wireless communication of the second base station.

Further, in addition to the wireless communication systems of the aforementioned respective inventions, a wireless communication system of the present invention comprises a service control station, connected to a backbone network to which the first base station is connected, for receiving the control information from the first base station, and based on the control information, managing the terminal station which uses both of the first base station and the second base station.

Thereby, an existing service control station can also receive control information on the communication channel of the second base station via the first base station, and hence it becomes unnecessary to newly provide a service control station for the second base station, whereby communication capacity can be increased at a lower cost.

Furthermore, in addition to the wireless communication systems of the aforementioned respective inventions, a wireless communication system of the present invention comprises a service control station, connected to a backbone network to which the first base station is connected, for managing the terminal station which uses both of the first base station and the second base station, wherein the second base station supplies information on charging for the use of the communication channel of its own to the first base station, the first station transfers the information on charging from the second base station to the service control station, and the service control station performs charging management of the terminal station based on the information on charging.

As a result, the existing service control station can receive the charging information on the communication channel of the second base station, and hence it becomes unnecessary to newly provide a service control station for the second base station, whereby communication capacity can be increased at a lower cost.

Moreover, in a wireless communication system of the present invention, in addition to the wireless communication systems of the aforementioned respective inventions, the first base station controls the second base station based on the control information from the terminal station so that the communication channel is established.

Consequently, it becomes unnecessary that the second base station sets up a control channel, and the first base station can easily manage a communication service provided by the second base station.

Further, in a wireless communication system of the present invention, in addition to the wireless communication systems of the aforementioned respective inventions, the second base station is connected to a communication network whose speed is higher than that of a backbone network to which the first base station is connected.

Accordingly, even if the backbone network to which the first base station is connected is an existing low-speed communication network, the connection of the second base station to a new high-speed communication network makes it possible to easily secure required communication capacity.

Furthermore, in a wireless communication system of the present invention, in addition to the wireless communication systems of the aforementioned respective inventions, the second base station uses the communication channel as a channel dedicated to a downlink to the terminal station, and the first base station establishes a communication channel dedicated to an uplink from the terminal station and performs wireless communication on data via the communication channel.

Thereby, the uplink and the downlink are separated, whereby data can be transmitted efficiently, and for this communication channel, only a receiving part and a transmitting part respectively need to be provided in the terminal station and the second base station, which can reduce costs of these stations.

Moreover, in a wireless communication system of the present invention, in addition to the wireless communication systems of the aforementioned respective inventions, the communication channel of the second base station is used as any of a channel dedicated to an uplink, a channel dedicated to a downlink, and a channel dedicated to a bidirectional link in accordance with user's selection.

Therefore, the most suitable wireless communication can be provided according to a usage pattern of wireless communication by the user.

Further, in addition to the wireless communication systems of the aforementioned respective inventions, a wireless communication system of the present invention comprises an area complementing base station for performing wireless communication on data with the terminal station located both inside a cell area of the first base station and outside a cell area of the second base station via a communication channel.

Accordingly, even when the cell area of the second base station is narrower than the cell area of the first base station, the terminal station can use the communication channel similar to that of the second base station based on the area complementing base station, whereby a stable communication service can be provided.

Furthermore, in a wireless communication system of the present invention, in addition to the wireless communication systems of the aforementioned respective inventions, when the terminal station uses the area complementing base station, the first base station which governs a cell area in which the terminal station is located performs wireless communication on the control information with the terminal station, which uses the communication channel of the area complementing base station, via the control channel.

Consequently, it becomes unnecessary that the area complementing base station sets up a control channel, and the first base station can manage a communication service provided by the area complementing base station.

Moreover, in a wireless communication system of the present invention, in addition to the wireless communication systems of the aforementioned respective inventions, the second base station is connected to a backbone network to which the first base station is connected.

Thereby, communication capacity can be increased at a lower cost without a new communication network being laid.

Further, in addition to the wireless communication systems of the aforementioned respective inventions, a wireless communication system of the present invention comprises a data communication line which connects the first base station and the second base station.

As a result, since both of a communication network to which the first base station is connected and a communication network to which the second base station is connected are used for data communication, communication speed and communication capacity can be increased more.

A base station of the present invention comprises: a communicating part for performing wireless communication on control information with a terminal station via a control channel; and a transmitting part for transmitting the control information to a different base station which performs wireless communication on data with the terminal station via a communication channel.

Thereby, a wireless communication system capable of increasing communication capacity at a low cost can be realized making use of facilities of the existing communication system.

Moreover, in a base station of the present invention, in addition to the base station of the aforementioned invention, the base station transmits synchronous control information for allowing the different base station to perform wireless communication synchronously, to the different base station via the control channel.

As a result, it is simplified that this base station controls the wireless communication of the different base station.

Further, in addition to the base stations of the aforementioned respective inventions, a base station of the present invention comprises a network communication part for transmitting information on charging for use of the communication channel of the different base station by the terminal station to a service control station which manages the terminal station.

Accordingly, control information on the communication channel of the different base station can be transmitted to the existing service control station through this base station, whereby it becomes unnecessary to newly provide a service control station for the different base station, which can increase the communication capacity of the wireless communication system at a lower cost.

Furthermore, in a base station of the present invention, in addition to the base stations of the aforementioned respective inventions, the communicating part receives data via a communication channel dedicated to an uplink from the terminal station, and the transmitting part transmits control information for establishment of the communication channel as a channel dedicated to a downlink to the terminal station, to the different base station.

Thereby, the uplink and the downlink of wireless communication are separated, whereby data can be transmitted efficiently.

Moreover, in a base station of the present invention, in addition to the base stations of the aforementioned respective inventions, the base station operates in accordance with a control program stored in a rewritable memory.

Consequently, the base station of the present invention can be realized by only changing a control program of the exiting base station and in addition, it can increase communication capacity at a low cost while making use of the facilities of the existing communication system.

A base station of the present invention comprises: a receiving part for receiving control information from a different base station which performs wireless communication on control information with a terminal station via a control channel; and a communicating part for establishing a communication channel based on the control information from the different base station and performing wireless communication on data with the terminal station via the communication channel.

As a result, a wireless communication system capable of increasing communication capacity at a low cost can be realized making use of the facilities of the existing communication system.

Moreover, in a base station of the present invention, in addition to the base station of the aforementioned invention, the receiving part receives synchronous control information for wireless communication in synchronization with the different base station via the control channel of the different base station, and the communicating part performs wireless communication in synchronization with wireless communication of the different base station based on the synchronous control information received from the receiving part.

Thereby, it is simplified that the different base station controls wireless communication of this base station. Moreover, it is possible to reduce a scale of a circuit for synchronization of wireless communication with the terminal station.

Further, in a base station of the present invention, in addition to the base stations of the aforementioned inventions, the base station is connected to a communication network whose speed is higher than that of a backbone network to which the different base station is connected.

Therefore, by connecting this base station to a new high-speed communication network, even if the backbone network to which the different base station is connected is the existing low-speed communication network, required communication capacity can be easily secured.

Furthermore, in a base station of the present invention, in addition to the base stations of the aforementioned inventions, the base station establishes the communication channel as a channel dedicated to a downlink to the terminal station.

Accordingly, the uplink and the downlink of wireless communication are separated, whereby data can be transmitted efficiently, and for this communication channel, only a receiving part and a transmitting part respectively need to be provided in the terminal station and this base station, which can reduce costs of these stations.

Moreover, in addition to the base stations of the aforementioned inventions, a base station of the present invention comprises a transmitting part for transmitting information on charging for use of the communication channel via the different base station to a service control station which is connected to a backbone network to which the different base station is connected and manages the terminal station.

Accordingly, it is unnecessary to newly provide a service control station for this base station, which increase communication capacity at a lower cost.

A terminal station of the present invention comprises: a first radio, connected to a first base station via a first wireless communication line, for performing wireless communication on control information with the first base station via a control channel; and a second radio, connected to a second base station via a second wireless communication line, for performing wireless communication on data with the second base station via a communication channel.

Thereby, a wireless communication system capable of increasing communication capacity at a low cost can be realized making use of the facilities of the exiting communication system.

Moreover, in a terminal station of the present invention, in addition to the terminal station of the aforementioned invention, the first radio transmits data via a communication channel dedicated to an uplink to the first base station, and the second radio receives data by using the communication channel as a channel dedicated to a downlink from the second base station.

Hence, the uplink and the downlink of wireless communication are separated, whereby data can be transmitted efficiently, and for this communication channel, only a receiving part and a transmitting part respectively need to be provided in this terminal station and the second base station, which can reduce costs of these stations.

A wireless communication method of the present invention comprises the steps of: connecting a terminal station to a first base station via a first wireless communication line; performing wireless communication on control information between the terminal station and the first base station via a control channel; connecting the terminal station to a second base station via a second wireless communication line; and performing wireless communication on data between the terminal station and the second base station via a communication channel, based on the control information.

Accordingly, this can increase communication capacity at a low cost while making use of the facilities of the existing communication system.

### BRIEF DESCRIPTION OF DRAWINGS

FIG. 1 is a block diagram showing a wireless communication system according to an embodiment 1 of the present invention;

FIG. 2 is a diagram showing an example of the configuration of cells in the embodiment 1;

FIG. 3 is a block diagram showing an example of the configuration of a terminal station in FIG. 1;

FIG. 4 is a block diagram showing a more detailed example of the configuration of the terminal station in FIG. 1;

FIG. 5 is a block diagram showing channels between a first and a second base station and terminal stations in the embodiment 1;

FIG. 6 is a block diagram showing the configuration of a wireless communication system according to an embodiment 2 of the present invention;

FIG. 7 is a block diagram showing the relation between base stations and a terminal station in an embodiment 3;

FIG. 8 is a block diagram showing the configuration of a base station according to an embodiment 4 of the present invention;

FIG. 9 is a block diagram showing the configuration of a base station according to an embodiment 5 of the present invention;

FIG. 10 is a block diagram showing the configuration of a radio of a terminal station which communicates with a second base station in an embodiment 6;

FIG. 11 is a block diagram showing the configuration of the second base station in the embodiment 6;

FIG. 12 is a sequence diagram showing an example of call control of a wireless communication system according to the embodiment 6;

FIG. 13 is a diagram showing an example of a frame structure in wireless communication by the first base station and the second base station;

FIG. 14 is a diagram showing an example of a frequency band used for a communication channel by the second station and all bands used by all the first base stations; and

FIG. 15 is a block diagram showing an example of the configuration of another terminal station.

### BEST MODE FOR CARRYING OUT THE INVENTION

Embodiments of the present invention will be explained below based on the drawings.

Embodiment 1.

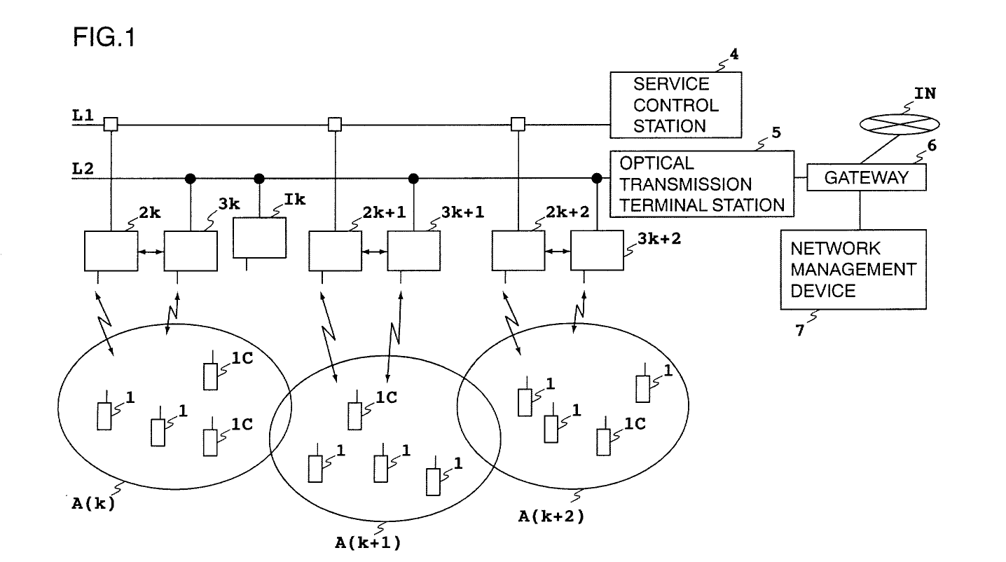

FIG. 1 is a block diagram showing a wireless communication system according to the embodiment 1 of the present invention. In FIG. 1, the wireless communication system according to the embodiment 1 includes a plurality of first base stations 2k, 2k+1, 2k+2 (only the k-th to k+2-th first base stations are shown as representation herein) and a plurality of second base stations 3k, 3k+1, 3k+2 (only the k-th to k+2-th second base stations are shown as representation herein) disposed corresponding to the first base stations. Each of the first base stations 2k, 2k+1, and 2k+2 can transmit and receive control information via a control channel at least, and each of the second base stations 3k, 3k+1, and 3k+2 can transmit and receive data via a communication channel.

Each of the first base stations 2k, 2k+1, and 2k+2 is a base station of a cellular communication system such as existing PDC (Personal Digital Cellular) or PHS (Personal Handyphone System) and transmits and receives data via a control channel and a communication channel according to this system. Moreover, each of the first base stations 2k, 2k+1, and 2k+2 transmits and receives control information and data, which are transmitted to and received from terminal stations 1 and IC, via a first communication line L1 being a backbone network. Furthermore, the first base stations 2k, 2k+1, and 2k+2 are connected to a service control section 4 via the communication line L1 and transmits control information from the terminal stations 1 and IC and the second base stations 3k, 3k+1, 3k+2 to the service control station 4.

Incidentally, the communication line L1 is, for example, ISDN.

Moreover, the control channel is a channel for transmission of control information being information necessary for location registration, origination/termination control, channel switching control, call ending control, charging processing, handover, and other communication controls, and the communication channel is a channel for transferring data transmitted and received by a user.

Each of the second base stations 3k, 3k+1, and 3k+2 is a base station which is provided to increase the capacity of communication with the terminal station 1 and connected to a second communication line L2 being a communication network identical with or different from that of the first base stations 2k, 2k+1, and 2k+2, and can transmit and receive (or transmit) data to/from the terminal station 1 via the communication channel.

In addition, a multi-access system and a modulation/demodulation system by each of the second base stations 3k, 3k+1, and 3k+2 may be identical with or different from those by each of the first base stations 2k, 2k+1, and 2k+2.

Moreover, each of the second base stations 3k, 3k+1, and 3k+2 transmits and receives data, which is transmitted to and received from the terminal station 1 via the communication channel, via the communication line L2. Incidentally, it is desirable that a communication network such as a high-speed optical network whose speed is higher than that of the communication line L1 be used for the communication line L2, since a large capacity of data is transmitted and received via the communication channel by each of the second base stations 3k, 3k+1, and 3k+2.

An area complementing base station Ik is a base station similar to the second base stations 3k, 3k+1, and 3k+2, and it is connected to the communication line L2 and covers an area not covered by cell areas of the second base stations 3k, 3k+1, and 3k+2 and within cell areas of the first base stations 2k, 2k+1, and 2k+2.

The terminal station 1C is a terminal device such as a cellular phone, PDA (Personal Digital Assistant), or a handheld computer, capable of performing wireless communication with the first base stations 2k, 2k+1, and 2k+2 as existing cellular communication system base stations. This terminal station 1C secures synchronization of wireless communication and performs various kinds of controls by the communication channel of each of the first base stations 2k, 2k+1, and 2k+2, and performs communication via the communication channel of each of these first base stations 2k, 2k+1, and 2k+2. Namely, the terminal station 1C is a conventional mobile terminal device, and in this system, such a conventional mobile terminal device can be used as usual.

Meanwhile, the terminal station 1 is a terminal device such as a cellular phone, PDA, or a handheld computer, capable of performing wireless communication with the first base stations 2k, 2k+1, and 2k+2 as the existing cellular communication system base stations and also performing communication with the additional second base stations 3k, 3k+1, and 3k+2.

A cell A(k) is an area under the control of the first base station 2k and the second base station 3k, the terminal station 1 in the cell A(k) performs wireless communication with the first base station 2k and the second base station 3k, and the terminal station 1C in the cell A(k) performs wireless communication with the first base station 2k. Similarly, a cell A(k+1) is an area under the control of the first base station 2k+1 and the second base station 3k+1, the terminal station 1 in the cell A(k+1) performs wireless communication with the first base station 2k+1 and the second base station 3k+1, and the terminal station 1C in the cell A(k+1) performs wireless communication with the first base station 2k+1. Moreover, a cell A(k+2) is an area under the control of the first base station 2k+2 and the second base station 3k+2, the terminal station 1 in the cell A(k+2) performs wireless communication with the first base station 2k+2 and the second base station 3k+2, and the terminal station 1C in the cell A(k+2) performs wireless communication with the first base station 2k+2.

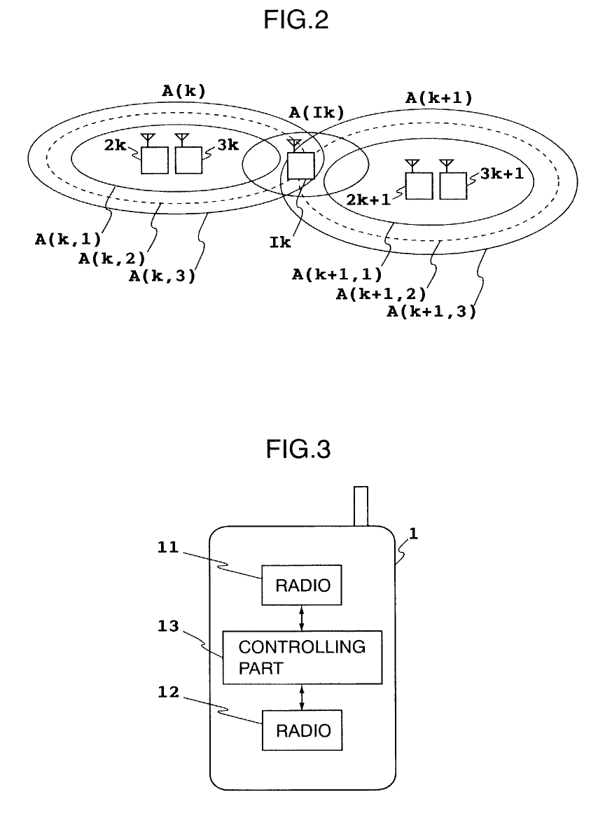

FIG. 2 is a diagram showing an example of the configuration of the cells in the embodiment 1. In FIG. 2, the sizes of the areas of the cells A(k) and A(k+1) differ depending on whether communication is performed by the first base stations 2k and 2k+1 or by the second base stations 3k and 3k+1. Since the first base stations 2k and 2k+1 are the existing communication system base stations, the cells of the adjacent first base stations 2k and 2k+1 are established so that a gap is not formed therebetween.

On the other hand, the sizes of the cells of the newly-established second base stations 3k and 3k+1 change according to a frequency band, a communication speed, output power, a placement condition of an antenna adopted by each of the second base stations 3k and 3k+1.

In FIG. 2, for example, the areas of cells when the second base stations 3k and 3k+1 communicate at the highest speed are shown by A(k, 1) and A(k+1, 1), the areas of cells when they communicate at a low speed are shown by A(k, 2) and A(k+1, 2), and the areas thereof when the existing first base stations 2k and 2k+1 communicate are shown by A(k, 3) and A(k+1, 3). Generally, as communication is performed at a higher speed, the cell area tends to become narrower.

When the areas of the cells A(k) and A(k+1) are A(k, 1) and A(k+1, 1) respectively, as shown in FIG. 2, an area between the two areas A(k, 1) and A(k+1, 1) is complemented by a cell A(Ik) of the area complementing base station Ik.

The service control station 4 is a service control station connected to the existing cellular communication system, and a device for performing management such as charging management on the terminal stations 1 and 1C based on control information from the first base stations 2k, 2k+1, and 2k+2. Moreover, the service control station 4 performs location registration processing on the terminal stations 1 and 1C based on the control information to certainly keep track of the locations of the terminal stations 1 and 1C even if each of the terminal stations 1 and 1C moves to any cell.

An optical transmission terminal station 5 is a termination station of the communication line L2 to which the second base stations 3k, 3k+1, and 3k+2 are connected and a device for transmitting and receiving data via the communication line L2.

A gateway 6 is a device for connecting the optical transmission terminal station 5 to an external network such as Internet IN.

A network management device 7 is a device for connecting the gateway 6 to a local area network (LAN) not illustrated.

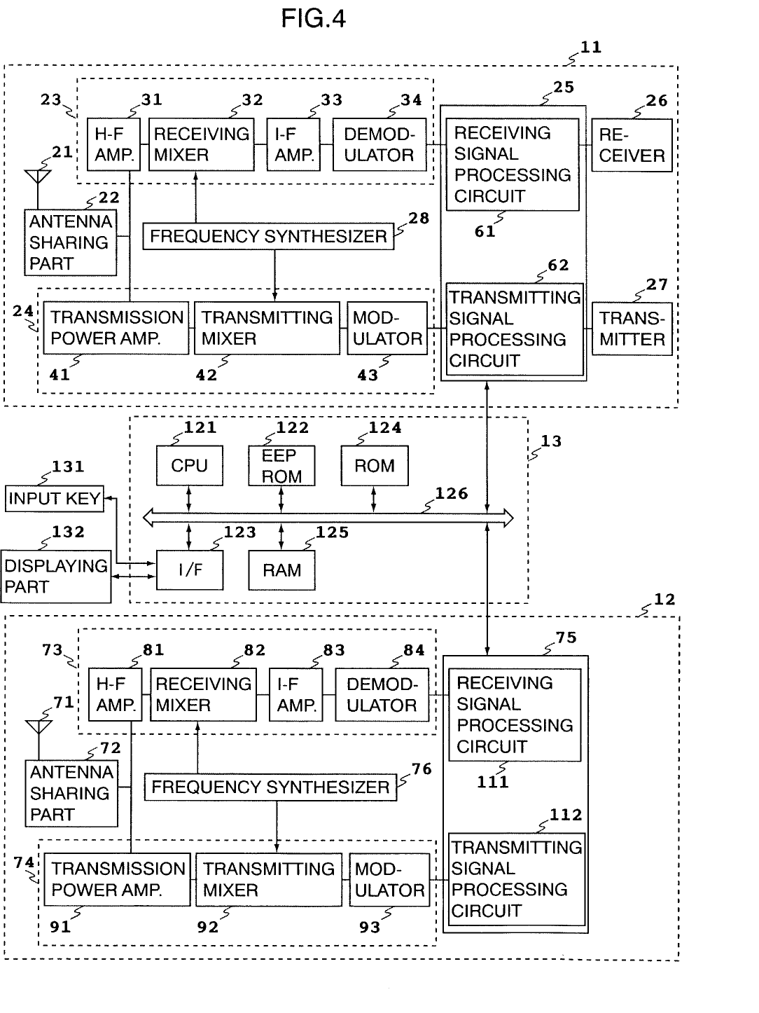

FIG. 3 is a block diagram showing an example of the configuration of the terminal station 1 in FIG. 1. FIG. 4 is a block diagram showing a more detailed example of the configuration of the terminal station 1 in FIG. 1.

As shown in FIG. 3, the terminal station 1 has a radio 11 corresponding to the existing communication system first base stations 2k, 2k+1, and 2k+2, a radio 12 corresponding to the second base stations 3k, 3k+1, and 3k+2 in order to increase communication capacity, and a controlling part 13 for controlling these radios 11 and 12.

In the radio 11 shown in FIG. 4, an antenna 21 is a device for sensing or emitting radio waves, and an antenna sharing part 22 is a circuit for using the antenna 21 as both a receiving antenna and a transmitting antenna.

A receiving part 23 is a circuit for extracting a signal transmitted from each of the first base stations 2k, 2k+1, and 2k+2 from sensed RF (Radio Frequency) signals. A high-frequency amplifier 31 is a circuit for amplifying the RF signals. A receiving mixer 32 is a circuit for converting the frequency of amplified RF signals. An intermediate-frequency amplifier 33 is a circuit for amplifying IF (Intermediate Frequency) signals after frequency conversion. A demodulator 34 is a circuit for demodulating the IF signals and extracting the transmitted signal.

Moreover, a transmitting part 24 is a circuit for converting a signal to be transmitted to each of the first base station 2k, 2k+1, and 2k+2 into an RF signal and outputting it. A modulator 43 is a circuit for modulating the signal to be transmitted by a predetermined modulation method. A transmitting mixer 42 is a circuit for frequency-converting an IF signal after the modulation into an RF signal. A transmission power amplifier 41 is a circuit for amplifying power of the RF signal.

Further, a baseband signal processing part 25 has a receiving signal processing circuit 61 for performing various processings for a signal received by the receiving part 23 and a transmitting signal processing circuit 62 for performing various processings for a signal to be transmitted by the transmitting part 24.

A receiver 26 is a device for converting voice data out of received data into an analog signal and outputting a voice corresponding to the analog signal after the conversion.

A transmitter 27 is a device for acquiring a voice of a user or the like as an analog voice signal and converting the voice signal into digital data.

A frequency synthesizer 28 is a circuit for generating a local oscillation signal.

In the radio 12 shown in FIG. 4, an antenna 71 is a device for sensing or emitting radio waves, and an antenna sharing part 72 is a circuit for using the antenna 71 as both a receiving antenna and a transmitting antenna.

Moreover, a receiving part 73 is a circuit for extracting a signal transmitted from each of the second base stations 3k, 3k+1, and 3k+2 from sensed RF signals. A high-frequency amplifier 81 is a circuit for amplifying RF signals. A receiving mixer 82 is a circuit for frequency-converting the amplified RF signals into IF signals. An intermediate-frequency amplifier 83 is a circuit for amplifying the IF signals. A demodulator 84 is a circuit for demodulating the IF signals and extracting the transmitted signal.

Further, a transmitting part 74 is a circuit for converting a signal to be transmitted to each of the second base stations 3k, 3k+1, and 3k+2 into an RF signal and outputting it. A modulator 93 is a circuit for modulating the signal to be transmitted by a predetermined modulation method. A transmitting mixer 92 is a circuit for frequency-converting an IF signal after the modulation into an RF signal. A transmission power amplifier 91 is a circuit for amplifying power of the RF signal.

A baseband signal processing part 75 has a receiving signal processing circuit 111 for performing various processings for a signal received by the receiving part 73 and a transmitting signal processing circuit 112 for performing various processings for a signal to be transmitted from the transmitting part 74.

A frequency synthesizer 76 is a circuit for generating a local oscillation signal.

In the controlling part 13 shown in FIG. 4, a CPU 121 is a device for controlling the internal parts of the terminal station 1 according to a program stored in a ROM 124 and/or an EEPROM 122. The EEPROM 122 is an electrically erasable and writable ROM such as a flash memory for storing a control program, various parameters, a table and the like. An interface 123 is a circuit for receiving data input from an input key 131 and performing data output to a displaying part 132. The ROM 124 is a memory in which the control program, a predetermined constant, and the like are stored. A RAM 125 is a memory used as a work area. A bus 126 is a circuit for connecting the CPU 121, the EEPROM 122, the interface 123, the ROM 124, and the RAM 125 to one another and connecting them to the baseband signal processing part 25 of the radio 11 and the baseband signal processing part 75 of the radio 12.

In addition, if there are sharable parts in the antennas 21 and 71, the antenna sharing parts 22 and 72, the receiving parts 23 and 73, the transmitting parts 24 and 74, the baseband signal processing parts 25 and 75, and so on in the radio 11 and the radio 12, these parts may be structured as the same circuit.

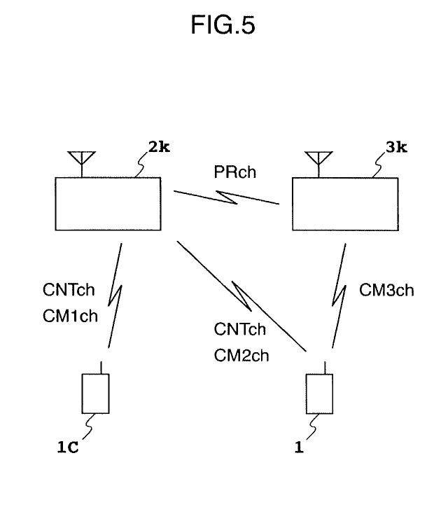

Next, the operation of the aforementioned system will be explained. FIG. 5 is a block diagram showing channels between the first and second base stations 2k and 3k and the terminal stations 1 and 1C in the embodiment 1. Incidentally, a case where the terminal stations 1 and 1C are located in the cell A(k) will be described with reference to FIG. 5. A case where the terminal stations 1 and 1C are located in other cells is the same as this.

First, the terminal station 1C can communicate with the existing first base station 2k as usual.

Meanwhile, the terminal station 1 can communicate with the existing first base station 2k and also communicate with the new second base station 3k.

The terminal station 1 transmits and receives control information via a control channel of the first base station 2k to secure synchronization of wireless communication and perform various kinds of controls so as to make the second base station 3k assign a communication channel, through the first base station 2k, and performs communication via the communication channel.

In addition, the first base station 2k and the second base station 3k transmit and receive synchronous control information via the control channel of the first base station 2k, and secure synchronization of wireless communication based on the contents or receiving timing of the synchronous control information.

For example, in the cell A(k), as shown in FIG. 5, the conventional terminal station 1C executes communication through the use of a control channel CNTch and a communication channel CM1ch of the first base station 2k, and the terminal station 1 executes communication through the use of the control channel CNTch and a communication channel CM2ch of the first base station 2k, and the use of a communication channel CM3ch of the second base station 3k.

The second base station 3k communicates with the first base station 2k via a predetermined channel PRch and transmits information on connection and disconnection, that is, information on charging, of the terminal station 1 to the service control station 4 through the first base station 2k. Accordingly, it is unnecessary to provide another service control station for charging management of the second base station 3k. The channel PRch may be a control channel or a communication channel. In addition, the channel PRch may be either a wireless line or a wire line.

When communication via a communication channel of the second base station 3k is started, the terminal station 1 requests the second base station 3k through the first base station 2k to secure a communication channel. The second base station 3k searches for an unused communication channel and notifies the terminal station 1 through the first base station 2k of a secured communication channel CM3ch.

Then, the transmission of a large amount of communication data is executed via the communication channel CM3ch and when it is completed, the communication channel CM3ch is released.

Namely, the terminal station 1 transmits and receives control information whose volume is relatively small to/from the first base station 2k via the control channel, and transmits and receives user data whose information volume is relatively large to/from the second base station 3k via the communication channel dedicated to data communication.

Thereby, it becomes possible to increase communication capacity at a low cost while existing facilities are utilized effectively. Incidentally, when located in each of the cells of the plural first base stations 2k, 2k+1, and 2k+2, the terminal station 1 may perform communication by using communication channels of these first base stations 2k, 2k+1, and 2k+2 at the same time. In this case, communication capacity can be increased more.

Moreover, when the terminal station 1 is located both outside the areas under the control of the second base stations 3k, 3k+1, and 3k+2 and inside the cell A(Ik) under the control of the area complementing base station Ik, the terminal station 1 transmits and receives a large amount of communication data to/from the area complementing base station Ik via a communication channel dedicated to data communication.

For example, in the case shown in FIG. 2, outside the cell A(k) and the cell A(k+1), the area complementing base station Ik, in place of the second base station 3k and the second base station 3k+1, transmits and receives data to/from the terminal station 1 by using the communication channel. Incidentally, when the communication channel of the area complementing base station Ik is used, the first base station 2k (2k+1) to which this area complementing base station Ik is previously assigned transmits information on charging of this to the service control station 4.

Moreover, data transmitted through the communication line L2 is transmitted to and received from the Internet IN and/or the LAN not illustrated via the optical transmission terminal station 5, the gateway 6, and the network management device 7.

Thus, the terminal station 1 performs communication by using the control channels of the first base stations 2k, 2k+1, and 2k+2 and the communication channels of the second base stations 3k, 3k+1, and 3k+2.

In addition, when the terminal station1 1 moves between the cells of the first base stations 2k, 2k+1, and 2k+2, handover is performed as usual with regard to wireless communication by the first base stations 2k, 2k+1, and 2k+2, and this handover causes disconnection with the second base station 3k, 3k+1, or 3k+2 in the cell from which the terminal station 1 moves and connection to the second base station 3k, 3k+1, or 3k+2 in the cell to which the terminal station 1 moves, based on control by the first base stations 2k, 2k+1, or 2k+2 in cells from which and to which the terminal station 1 moves.

Moreover, the first base stations 2k, 2k+1, and 2k+2 are monitored via the communication line L1, while the second base stations 3k, 3k+1, and 3k+2 are monitored via the communication line L2 or monitored through the first base stations 2k, 2k+1, and 2k+2 and the communication line L1.

Further, the first base stations 2k, 2k+1, and 2k+2 receive a control program therefor from the service control station 4 via the communication line L1 to upgrade the control program. Meanwhile, the second base stations 3k, 3k+1, and 3k+2 download the control program via the communication line L2 or download the control program from the service control station 4 via the first base stations 2k, 2k+1, 2k+2 and the communication line L1 to upgrade the control program.

Now, the detailed operation of the terminal station 1 shown in FIG. 4 will be explained.

The controlling part 13 controls the displaying part 132 so that received data or various pieces of information is displayed to the user, and allows the displaying part 132 to display various pieces of information in response to the operation of the input key 131. Moreover, the controlling part 13 outputs various pieces of data to the baseband signal processing parts 25 and 75 in response to the operation of the input key 131, and besides performs various controls inside the terminal station 1. Further, the CPU 121 of the controlling part 13 operates in accordance with the control program, and controls the radios 11 and 12 as necessary so that communication is executed. On this occasion, data to be transmitted is supplied from the controlling part 13 to the radios 11 and 12, and received data is supplied from the radios 11 and 12 to the controlling part 13. Various pieces of control information is transmitted to and received from the radio 11.

In the radio 11 corresponding to the first base stations 2k, 2k+1, and 2k+2, a signal received from each of the first base stations 2k, 2k+1, and 2k+2 by the antenna 21 is inputted to the receiving part 23 through the antenna sharing part 22. After being high-frequency amplified by the high-frequency amplifier 31, the signal is inputted to the receiving mixer 32. The signal is frequency-converted by being mixed with a local oscillation signal from the frequency synthesizer 28 in the receiving mixer 32, and through the intermediate-frequency amplifier 33, demodulated by the demodulator 34. The receiving signal demodulated with respect to its own station is signal-processed by the receiving signal processing circuit 61 of the baseband signal processing part 25, and outputted to the receiver 26 or outputted to the displaying part 132.

Meanwhile, a voice signal from the transmitter 27 and/or data from the controlling part 13 is signal-processed in the transmitting signal processing circuit 62, and thereafter inputted to the transmitting part 24. After an output signal of the transmitting signal processing circuit 62 is subjected to a predetermined modulation processing in the modulator 43, its frequency is converted by the transmitting mixer 42 to which a local oscillation signal from the frequency synthesizer 28 is supplied, and its power is amplified by the transmission power amplifier 41, and thereafter transmitted from the antenna 21 to the first base stations 2k, 2k+1, and 2k+2 through the antenna sharing part 22.

In the radio 12 corresponding to the second base stations 3k, 3k+1, and 3k+2, a signal received from each of the first base stations 3k, 3k+1, and 3k+2 by the antenna 71 is inputted to the receiving part 73 through the antenna sharing part 72. After high-frequency amplified by the high-frequency amplifier 81, the signal is inputted to the receiving mixer 82. The signal is mixed with a local oscillation signal from the frequency synthesizer 76 and frequency-converted by the receiving mixer 82, and through the intermediate-frequency amplifier 83, demodulated by the demodulator 84. After the receiving signal demodulated with respect to its own station is signal-processed by the receiving signal processing circuit 111 of the baseband signal processing part 75, it is supplied to the controlling part 13 and, for example, outputted to the displaying part 132.

Meanwhile, data from the controlling part 13 is signal-processed in the transmitting signal processing circuit 112, and thereafter inputted to the transmitting part 74. Namely, after an output signal of the transmitting signal processing circuit 112 is subjected to a predetermined modulation processing in the modulator 93, its frequency is converted by the transmitting mixer 92 to which a local oscillation signal from the frequency synthesizer 76 is supplied, and its power is amplified by the transmission power amplifier 91, and thereafter transmitted from the antenna 71 to the second base station 3k, 3k+1, or 3k+2 through the antenna sharing part 72.

In addition, the radio 11 corresponding to the first base stations 2k, 2k+1, and 2k+2 may perform the control of transmitting/receiving sequence operation, control of demodulation/modulation of transmitting/receiving signals, control of transmitting/receiving protocols, and the like in the radio 12 corresponding to the second base stations 3k, 3k+1, and 3k+2.

Moreover, the radio 11 corresponding to the first base stations 2k, 2k+1, and 2k+2 may have a function of communicating with other terminal stations 1 in addition to the aforementioned functions.

It is naturally possible to perform data communication by the communication channels of the first base stations 2k, 2k+1, and 2k+2 simultaneously with data communication by the communication channels of the second base stations 3k, 3k+1, and 3k+2.

As stated above, according to the aforementioned embodiment 1, each of the first base stations 2k, 2k+1, and 2k+2 is connected to the terminal station 1 via the first wireless communication line and performs wireless communication on control information with the terminal station 1 via the control channel, and each of the second base stations 3k, 3k+1, and 3k+2 is connected to the terminal station 1 via the second wireless communication line, and based on the control information, performs wireless communication on data with the terminal station 1 via the communication channel. This makes it possible to increase communication capacity at a low cost while making use of facilities of the existing communication system.

Further, according to the aforementioned embodiment 1, the first base stations 2k, 2k+1, and 2k+2 transmit synchronous control information on wireless communication to the second base stations 3k, 3k+1, and 3k+2 via control channels, and the second base stations 3k, 3k+1, and 3k+2 receive the synchronous control information, and based on the received synchronous control information, perform wireless communication in synchronization with wireless communication of the first base stations 2k, 2k+1, and 2k+2. Thereby, it is simplified that the first base stations 2k, 2k+1, and 2k+2 control wireless communication of the second base stations 3k, 3k+1, and 3k+2.

Furthermore, according to the aforementioned embodiment 1, the service control station 4 is connected to the backbone network to which the first base stations 2k, 2k+1, and 2k+2 are connected, receives control information from the first base stations 2k, 2k+1, and 2k+2, and based on the control information, manages the terminal station 1 which uses both the first base stations 2k, 2k+1, and 2k+2 and the second base stations 3k, 3k+1, and 3k+2. Thereby, the existing service control station 4 can also receive control information on communication channels of the second base stations 3k, 3k+1, and 3k+2 through the first base stations 2k, 2k+1, and 2k+2, and hence it is unnecessary to newly provide a service control station for the second base stations 3k, 3k+1, and 3k+2, thereby enabling an increase in communication capacity at a lower cost.

Moreover, according to the aforementioned embodiment 1, the second base stations 3k, 3k+1, and 3k+2 supply information on charging for the use of their own communication channels by the terminal station 1 to the first base stations 2k, 2k+1, and 2k+2, the first base stations 2k, 2k+1, and 2k+2 transfer the information on charging from the second base stations 3k, 3k+1, and 3k+2 to the service control station 4, and the service control station 4 performs charging management of the terminal station 1 based on the information on charging. Thereby, the existing service control station 4 can receive charging information on the communication channels of the second base stations 3k, 3k+1, and 3k+2 through the first base stations 2k, 2k+1, and 2k+2, and hence it is unnecessary to newly provide a service control station for the second base stations 3k, 3k+1, and 3k+2, thereby enabling an increase in communication capacity at a lower cost.

Besides, according to the aforementioned embodiment 1, the first base stations 2k, 2k+1, 2k+2 control the second base stations 3k, 3k+1, 3k+2 based on control information from the terminal station 1 so that communication channels are established. Consequently, it is unnecessary that the second base stations 3k, 3k+1, and 3k+2 set up control channels, and the first base stations 2k, 2k+1, and 2k+2 can easily manage communication services provided by the second base stations 3k, 3k+1, and 3k+2.

Further, according to the aforementioned embodiment 1, the second base stations 3k, 3k+1, and 3k+2 are connected to a communication network whose speed is higher than that of the backbone network to which the first base stations 2k, 2k+1, and 2k+2 are connected. Thereby, by connecting the second base stations 3k, 3k+1, 3k+2 to a new high-speed communication network, even if the backbone network to which the first base stations 2k, 2k+1, and 2k+2 are connected is the existing low-speed communication network, required communication capacity can be easily secured.

Furthermore, according to the aforementioned embodiment 1, the area complementing base station Ik is provided for performing wireless communication on data with the terminal station 1 located inside the cell areas of the first base stations 2k, 2k+1, and 2k+2 and outside the cell areas of the second base stations 3k, 3k+1, and 3k+2 via a communication channel. Consequently, even if the cell areas of the second base stations 3k, 3k+1, and 3k+2 are smaller than the cell areas of the first base stations 2k, 2k+1, and 2k+2, this area complementing base station Ik enables the terminal station 1 to use the communication channel similar to those of the second base stations 3k, 3k+1, and 3k+2, whereby a stable communication service can be provided.

Moreover, according to the aforementioned embodiment 1, the first base station 2k, 2k+1, or 2k+2 which governs a cell area where the terminal station 1 is located performs wireless communication on control information via its control channel with the terminal station 1 which uses the communication channel of the area complementing base station Ik. As a result, the area complementing base station Ik need not set up a control channel, and the first base stations 2k, 2k+1, and 2k+2 can manage a communication service provided by the area complementing base station Ik.

In addition, according to the aforementioned embodiment 1, the terminal station 1 has the radio 11 connected to the first base stations 2k, 2k+1, and 2k+2 via the first wireless communication line, for performing wireless communication on control information with each of the first base stations 2k, 2k+1, and 2k+2 via the control channel, and the radio 12 connected to the second base stations 3k, 3k+1, and 3k+2 via the second wireless communication line, for performing wireless communication on data with each of the second base stations 3k, 3k+1, and 3k+2 via the communication channel based on the control information. Hence, it is possible to realize a wireless communication system capable of increasing communication capacity at a low cost while making use of facilities of the existing communication system.

Embodiment 2.

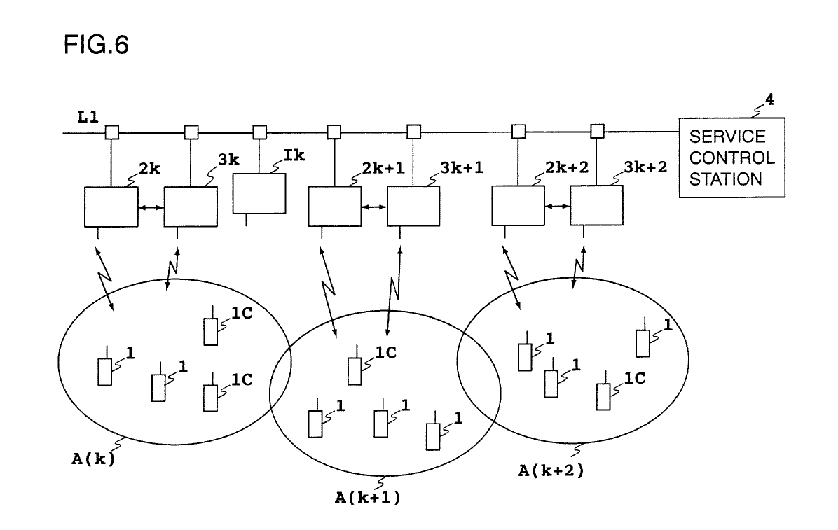

FIG. 6 is a block diagram showing the configuration of a wireless communication system according to the embodiment 2 of the present invention. The wireless communication system according to the embodiment 2 is a system in which the communication lines L1 and L2 in the embodiment 1 are integrated into one communication line L1 and all the base stations 2k to 2k+2, 3k to 3k+2, and Ik are connected to the communication line L1.

Namely, in the wireless communication system according to the embodiment 2, the second base stations 3k to 3k+2 use the same communication line as the first base stations 2k to 2k+2.

It should be noted that components in FIG. 6 are the same as those in the embodiment 1, and hence the explanation thereof is omitted.

As stated above, according to the aforementioned embodiment 2, the second base stations 3k, 3k+1, and 3k+2 are connected to a backbone network to which the first base stations 2k, 2k+1, and 2k+2 are connected, whereby communication capacity can be increased at a lower cost without a new communication network being laid.

Embodiment 3.

A wireless communication system according to the embodiment 3 of the present invention is designed to connect the first base station 2k and the second base station 3k which correspond to each other by a data communication line in order to allow the two communication lines L1 and L2 to be used for data communication.

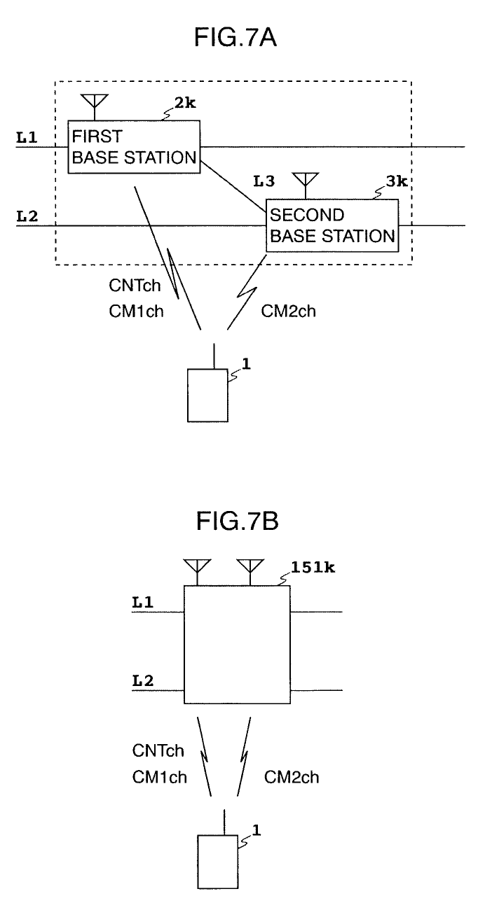

FIG. 7 is a block diagram showing the relation between base stations and a terminal station in the embodiment 3. In FIG. 7A, the terminal station 1 executes communication by using a control channel CNTch and a communication channel CM1ch of the first base station 2k and a communication channel CM2ch of the second base station 3k. The first base station 2k and the second base station 3k are connected by a third communication line L3 and can communicate with each other.

Moreover, as shown in FIG. 7B, the first base station 2k and the second base station 3k may be integrated into a one-piece device 151k, and the communication line L3 may be built in as an internal circuit.

Thus, the control of the second base station 3k by the first base station 2k can be easily performed, and data can be delivered between the first base station 2k and the second base station 3k, whereby both the communication lines L1 and L2 can be used for data communication as necessary. In other words, the transfer of data from one base station to the other via the communication line L3 enables both the communication lines L1 and L2 to be used for data communication.

As stated above, according to the aforementioned embodiment 3, the data communication line which connects the first base stations 2k, 2k+1, and 2k+2 and the second base stations 3k, 3k+1, and 3k+2 is provided, whereby both the communication lines L1 and L2 can be used for data communication, thereby enabling increased communication speed and larger communication capacity.

Embodiment 4.

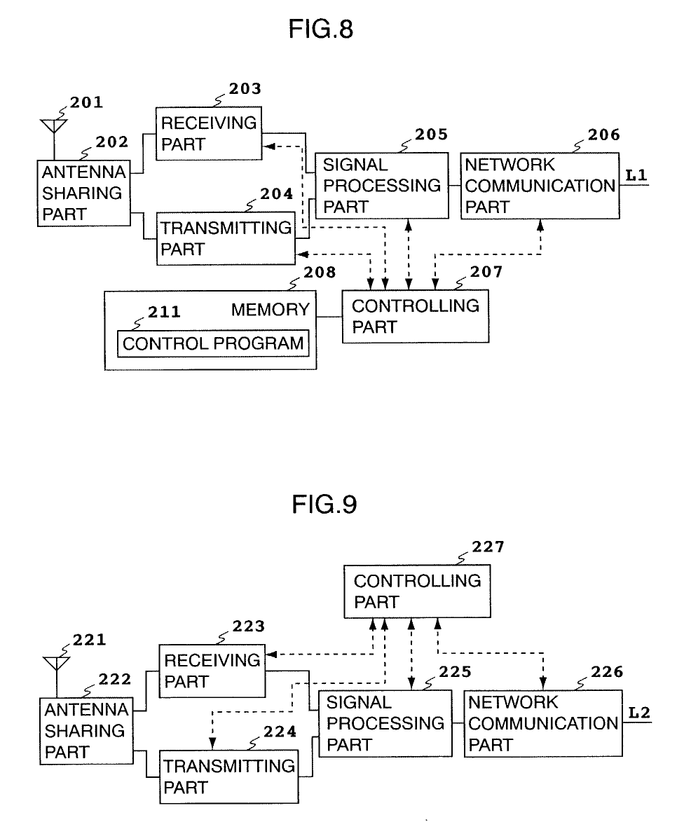

FIG. 8 is a block diagram showing the configuration of a base station according to the embodiment 4 of the present invention. This base station is used as each of the first base stations 2k, 2k+1, and 2k+2 in the wireless communication system according to the embodiment 1.

In FIG. 8, an antenna 201 is a device for sensing or emitting radio waves, and an antenna sharing part 202 is a circuit for using the antenna 201 as both a receiving antenna and a transmitting antenna.

Moreover, a receiving part 203 is a circuit for extracting signals transmitted from the conventional terminal station 1C and the radio 11 of the terminal station 1 from sensed RF signals.

Further, a transmitting part 204 is a circuit for converting signals to be transmitted to the conventional terminal station 1C and the radio 11 of the terminal station 1 into RF signals and outputting them.

Furthermore, a signal processing part 205 is a circuit for performing various processings to convert signals received by the receiving part 203 into data in voice communication and data communication and convert data in voice communication and data communication into signals to be transmitted by the transmitting part 204.

Moreover, a network communication part 206 is a circuit, connected to the communication line L1, for performing voice communication and data communication via the communication line L1.

Further, a controlling part 207 is a circuit, for example, including a CPU, for controlling each part according to a control program 211 stored in a memory 208, transmitting and receiving control information to/from the terminal stations 1C and 1 and a different base station (the second base station 3k in FIG. 1, for example), and operating based on the control information.

Furthermore, the memory 208 is a nonvolatile rewritable device such as an EEPROM for storing the control program 211.

In addition, this base station can be configured by changing a control program in the existing wireless communication-system base station to the control program 211.

Next, the operation of the aforementioned station will be explained.

The base station according to this embodiment 4 performs wireless communication with the conventional terminal station 1C and also with the terminal station 1 according to the control program 211. The operation with regard to wireless communication with the conventional terminal station 1C is the same as in the case of the existing wireless communication system, and hence the explanation thereof is omitted.

Moreover, a case where voice communication is performed in wireless communication with the terminal station 1 is the same as the case of voice communication with the conventional terminal station 1C, and hence the explanation thereof is omitted.

When the terminal station 1 performs data communication, a request for the establishment of a communication channel of the different base station (for example, the second base station 3k in FIG. 1) connected to this base station is received by the receiving part 203 from the terminal station 1 via a control channel, and supplied to the controlling part 207 through the signal processing part 205.

When receiving the request, the controlling part 207 controls the transmitting part 204 etc. so that predetermined control information is supplied to the different base station (the second base station) via the channel PRch, and thereby a communication channel for the terminal station 1 is established. When receiving notice that the communication channel is established from the different base station (the second base station) via the channel PRch, the controlling part 207 controls the signal processing part 205 and the transmitting part 204 so that the notice is transmitted to the terminal station 1 via the control channel.

After receiving the notice, the terminal station 1 performs data communication via the established communication channel of the different base station (the second base station).

The controlling part 207 controls the network communication part 206 so that information on charging for the use of the communication channel of the different base station (the second base station) by the terminal station 1 is transmitted to the service control station 4 which is connected to the communication line L1 and manages the terminal station 1.

As stated above, according to the aforementioned embodiment 4, the receiving part 203 and the transmitting part 204 function as communication parts for performing wireless communication on control information with the terminal station 1 via the control channel, and the transmitting part 204 transmits the control information to the different base station (the second base station) for performing wireless communication on data with the terminal station 1 via the communication channel. Therefore, by using this base station as each of the first base stations 2k, 2k+1, and 2k +2 of the wireless communication system according to the embodiment 1, the effects described in the embodiment 1 can be obtained.

Moreover, according to the aforementioned embodiment 4, the controlling part 207 operates according to the control program 211 stored in the rewritable memory 208. This makes it possible to realize this base station by only changing the control program of the exiting base station and in addition, to increase communication capacity at a low cost while making use of the facilities of the existing communication system.

Embodiment 5.

FIG. 9 is a block diagram showing the configuration of a base station according to the embodiment 5 of the present invention. This base station is used as each of the second base stations 3k, 3k+1, and 3k+2 in the wireless communication system according to the embodiment 1.

In FIG. 9, an antenna 221 is a device for sensing or emitting radio waves, and an antenna sharing part 222 is a circuit for using the antenna 221 as both a receiving antenna and a transmitting antenna.

Moreover, a receiving part 223 is a circuit for extracting a signal transmitted from the radio 12 of the terminal station 1 from sensed RF signals.

Further, a transmitting part 224 is a circuit for converting data to be transmitted to the radio 12 of the terminal station 1 into an RF signal and outputting it.

Furthermore, a signal processing part 225 is a circuit for performing various processings to convert the signal received by the receiving part 223 into data in data communication and convert data in data communication into a signal to be transmitted by the transmitting part 224.

Moreover, a network communication part 226 is a circuit, connected to the communication line L2, for performing data communication via the communication line L2.

A controlling part 227 is a circuit, for example, including CPU, for controlling each part according to control information from a different base station (for example, the first base station 2k in FIG. 1) connected to this base station.

Next, the operation of the aforementioned station will be explained.

The base station according to this embodiment 5 does not perform wireless communication with the conventional terminal station 1C but performs wireless communication with the terminal station 1.

When the terminal station 1 performs data communication, a request for the establishment of a communication channel of this base station is transmitted from the terminal station 1 via a control channel of the different base station (for example, the first base station 2k in FIG. 1) connected to this base station. The request is then supplied to the controlling part 227 from the different base station (the first base station) via the channel PRch.

When receiving the request, the controlling part 227 controls the signal processing part 225 so that the communication channel for the terminal station 1 is established. When the communication channel is established, the controlling part 227 supplies notice that the communication channel is established to the different base station (the first base station) via the channel PRch.

After receiving the notice via the control channel of the different base station (the first base station), the terminal station 1 performs data communication via the communication channel.

Data received and transmitted by the receiving part 223 and the transmitting part 224 in data communication is transmitted to and received from the communication line L2 by the network communication part 226.

As stated above, according to the aforementioned embodiment 5, the receiving part 223 receives control information from the different base station (the first base station) which performs wireless communication on the control information with the terminal station 1 via the control channel, and the receiving part 223 and the transmitting part 224 establish the communication channel based on the control information from the different base station (the first base station) and function as a communicating part for performing wireless communication on data with the terminal station 1 via the communication channel. Therefore, by using this base station as each of the second base stations 3k, 3k+1, and 3k+2 of the wireless communication system according to the embodiment 1, the effects described in the embodiment 1 can be obtained. Moreover, by utilizing timing of wireless communication of the first base stations 2k, 2k+1, and 2k+2, the scale of a circuit for synchronization of wireless communication with the terminal station 1 can be reduced.

Embodiment 6.

A wireless communication system according to the embodiment 6 of the present invention is designed in such a manner that in data communication, a communication channel of each of the second base stations 3k, 3k+1, 3k+2 is only dedicated to a downlink to the terminal station 1, and a communication channel of each of the first base stations 2k, 2k+1, and 2k+2 is only dedicated to an uplink from the terminal station 1.

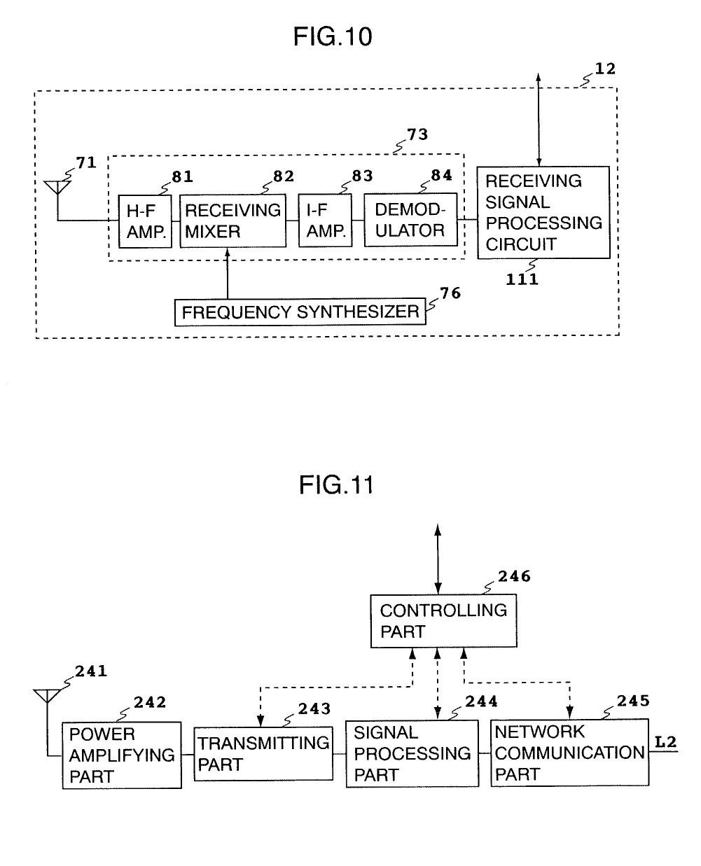

FIG. 10 is a block diagram showing the configuration of the radio 12 of the terminal station 1 which communicates with the second base station 2k, 2k+1, 2k+2 in the embodiment 6. As shown in FIG. 10, the radio 12 of the terminal 1 in the embodiment 6 is configured by deleting the antenna sharing part 72, the transmitting part 74, and the transmitting signal processing circuit 112 from the radio 12 of the terminal station 1 in the embodiment 1. Incidentally, other components of the terminal station 1 in the embodiment 6 are the same as those in the embodiment 1, and hence the explanation thereof is omitted.

FIG. 11 is a block diagram showing the configuration of each of the second base stations 3k, 3k+1, and 3k+2 in the embodiment 6. In FIG. 11, an antenna 241 is a transmitting antenna for emitting radio waves, and a power amplifying part 242 is a circuit for amplifying power of an RF signal and applying the signal to the antenna 241.

Moreover, a transmitting part 243 is a circuit for converting data to be transmitted to the radio 12 of the terminal station 1 into an RF signal and outputting it.

Further, a signal processing part 244 is a circuit for performing various processings to convert data in data communication into a signal to be transmitted by the transmitting part 243.

Furthermore, a network communication part 245 is a circuit, connected to the communication line L2, for performing data communication via the communication line L2.

Moreover, a controlling part 246 is a circuit, for example, including CPU, for controlling each part according to control information from the first base stations 2k, 2k+1, and 2k+2 connected to these second base stations 3k, 3k+1, and 3k+2. In this case, the control information is directly transmitted to and received from the controlling part 207 of each of the first base stations 2k, 2k+1, and 2k+2 via the channel PRch of a wire link. Incidentally, when the control information is transmitted and received via the channel PRch of a wireless line, the receiving part 223 and so on become necessary as shown in FIG. 9.

Incidentally, other components in the wireless communication system according to the embodiment 6 are the same as those in the embodiment 1, and hence the explanation thereof is omitted.

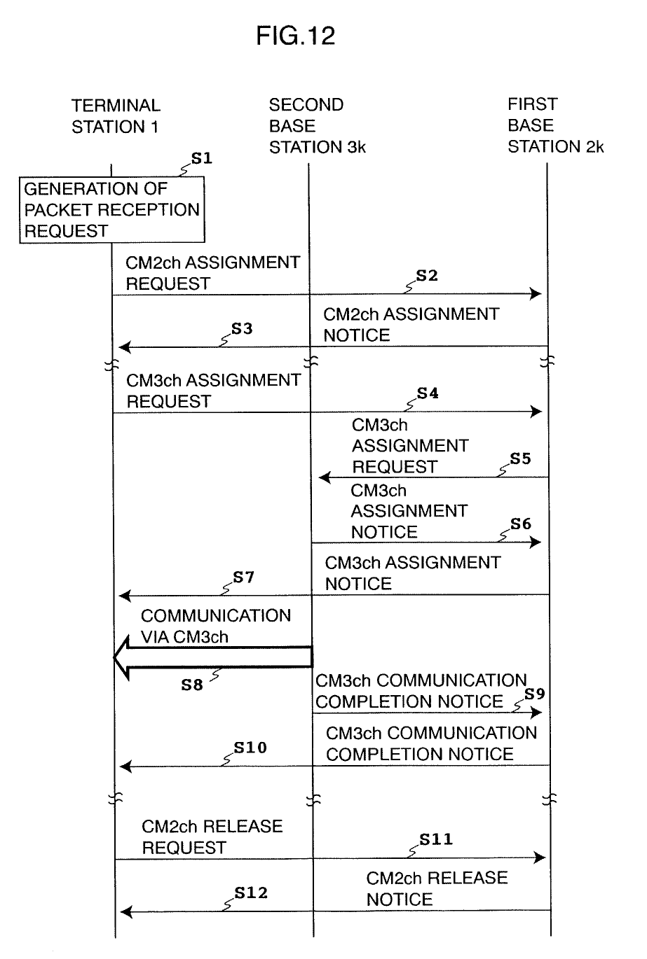

Next, the operation of the aforementioned system will be explained. FIG. 12 is a sequence diagram showing an example of call control of the wireless communication system according to the embodiment 6. Incidentally, in FIG. 12, a case where the terminal station 1 is located in the cell A(k) is explained.

As shown in FIG. 12, when a packet reception request is generated while various processings are performed (step S1), the terminal station 1 transmits, by the radio 11, an assignment request for the communication channel CM2ch of the first base station 2k to the first base station 2k via the control channel (step S2).

When receiving the assignment request for its own communication channel CM2ch, the first base station 2k assigns the communication channel CM2ch to the terminal station 1 and transmits notice of this assignment to the terminal station 1 via the control channel (step S3).

When receiving the notice by the radio 11, the terminal station 1 performs uplink data communication via the communication channel CM2ch.

Subsequently, the terminal station 1 transmits an assignment request for the communication channel CM3ch of the second base station 3k to the first base station 2k (step S4).

When receiving the assignment request for the communication channel CM3ch of the second base station 3k, the first base station 2k supplies control information showing the assignment request for the communication channel to the second base station 3k (step S5).

When receiving the control information showing the assignment request for the communication channel, the second base station 3k assigns the communication channel CM3ch not in use to the terminal station 1 and supplies notice of this assignment to the first base station 2k (step S6).

When receiving the notice that the communication channel CM3ch is assigned from the second base station 3k, the first base station 2k transmits this notice to the terminal station 1 via the control channel (step S7).

After the transmission of this notice, the second base station 3k starts data communication with the terminal station 1 via the communication channel CM3ch (step S8). Thus, downlink data communication is performed from the second base station 3k to the terminal station 1.

In addition, the data communication from the second base station 3k to the terminal station 1 is executed in synchronization with existing data communication between the first base station 2k and the terminal station 1.

For example, in case that the first base station 2k is a PHS base station, one frame is transmitted in five milliseconds. Accordingly, in this case, the second base station 3k also transmits one frame in five milliseconds.

Incidentally, in the case of PHS, one frame is divided into eight slots, four slots are used for an uplink, and the remaining four slots are used for a downlink. One slot out of respective four slots is used as a control channel by all terminal stations 1 in a cell. The remaining slots are used as communication channels.

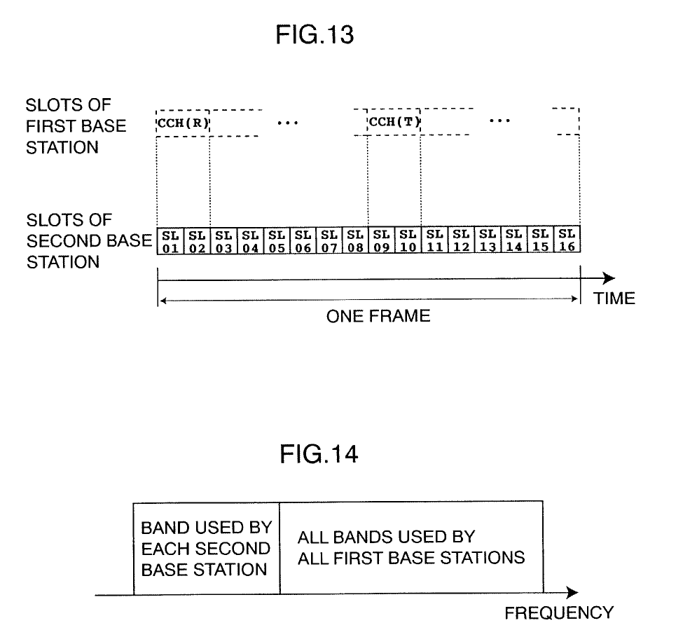

Meanwhile, a frame structure in the data communication from the second base station 3k to the terminal station 1 can be different from the aforementioned data communication between the first base station 2k and the terminal station 1. FIG. 13 is a diagram showing an example of a frame structure in wireless communication by the first base station 2k and the second base station 3k. For example, as shown in FIG. 13, one frame in the wireless communication by the second base station 3k may be divided into 16 slots SL01 to SL16, and one or plural slots may be assigned to one communication channel. On this occasion, synchronous control information is transmitted and received between the first base station 2k and the second base station 3k via control channels CCH(R) and CCH(T) assigned to two slots out of eight slots in one frame in the wireless communication by the first base station 2k as the PHS base station, and hence synchronization of the wireless communication by the first base station 2k and the second base station 3k is secured.

Moreover, for example, the communication channel of the second base station 3k is used as a synchronous burst channel SBCH aiming to regenerate a baseband clock and detect an error of a reference clock frequency between the second base station 3k and the terminal station 1 at the start of communication, and thereafter used as a user packet channel UPCH used for the transfer of user data.

Incidentally, a frequency band used for the communication channel by the second base station 3k is secured, for example, in addition to all bands used by all the first base stations 2k. FIG. 14 is a diagram showing an example of the frequency band used for the communication channel by one second base station 3k and all the bands used by all the first base stations 2k, . . . . As shown in FIG. 14, a band adjacent to all the bands used by all the first base stations 2k, . . . may be shared as a communication channel among all the second base stations 3k, . . . .

However, when the first base station 2k and the second base station 3k in the same cell are not influenced by each other even when they use the same band owing to the type of a communication system and the like, both of them may use the same band.

In this way, data communication via the communication channel CM3ch is performed by the second base station 3k.

Thereafter, when the data communication via the communication channel CM3ch is completed, the second base station 3k supplies a communication completion notice to the first base station 2k (step S9), and the first base station 2k transmits the communication completion notice to the terminal station 1 (step S10).

When uplink data communication by the radio 11 is also completed after the terminal station 1 receives the communication completion notice, the terminal station 1 transmits a request for release of the communication channel CM2ch to the first base station 2k via the control channel (step S11).

When receiving the release request, the first base station 2k releases the communication channel CM2ch for the terminal station 1, and transmits notice of the release to the terminal station 1 (step S12).

As stated above, according to the aforementioned embodiment 6, each of the second base stations 3k, 3k+1, and 3k+2 uses a communication channel as one dedicated to a downlink to the terminal station 1, each of the first base stations 2k, 2k+1, and 2k+2 establishes a communication channel dedicated to an uplink from the terminal station 1 and performs wireless communication on data via the communication channel. Consequently, the uplink and the downlink are separated, whereby data can be transmitted efficiently, and with respect to this communication channel, the transmitting part 74 in the radio 12 of the terminal station 1, and the receiving part 223 in each of the second base stations 3k, 3k+1, and 3k+2 become unnecessary, which enables a reduction in the costs of these devices.

Embodiment 7.

A wireless communication system according to the embodiment 7 of the present invention is designed so that the communication channel of each of the second base stations 3k, 3k+1, and 3k+2 is dedicated to an uplink from the terminal station 1, and the communication channel of each of the first base stations 2k, 2k+1, and 2k+2 is dedicated to a downlink from the terminal station 1.

Hence, contrary to the case of the embodiment 6, when a lot of data is transmitted from the terminal station 1, communication capacity can be increased efficiently.

Embodiment 8.

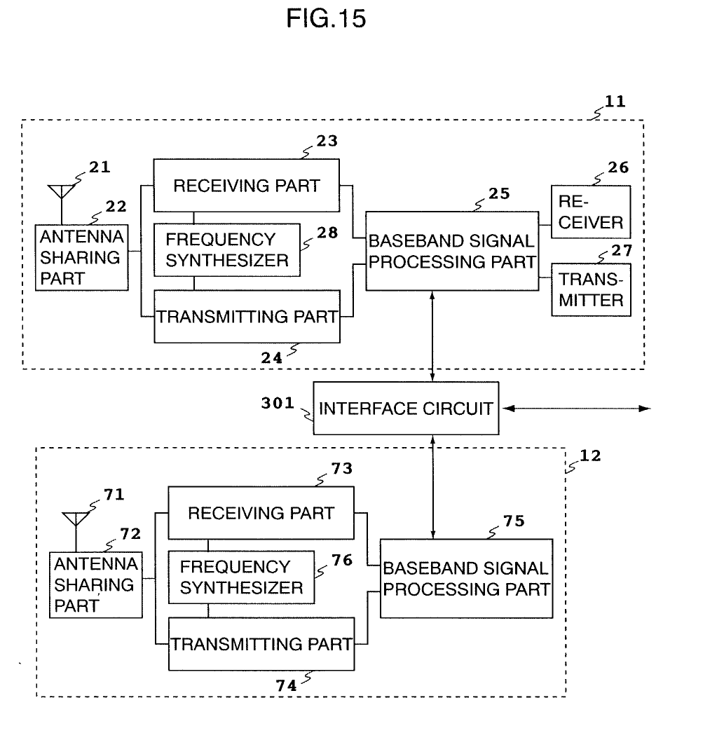

FIG. 15 is a block diagram showing an example of the configuration of another terminal station 1. In FIG. 15, an interface circuit 301 is a circuit for transmitting and receiving data by an interface standard connectable to a personal computer. For example, PCMCIA (Personal Computer Memory Card Interface) or USB (Universal Serial Bus) is named as the interface standard. This terminal station 1 may be structured as a PC card through the use of the PCMCIA.

Other components in FIG. 15 are the same as those in the embodiment 1, and hence the explanation thereof is omitted.

Next, the operation of the aforementioned station will be explained.

In the case of the embodiment 8, the user operates a personal computer to which this terminal station 1 is connected. According to the operation and processing by the personal computer, control signals and data are transmitted and received between the personal computer and the interface circuit 301.

Other operations are the same as those of the terminal station 1 in the embodiment 1, and hence the explanation thereof is omitted.

In addition, in the aforementioned embodiments, each of the first base stations 2k, 2k+1, 2k+2 can perform transmission and reception to/from the conventional terminal station 1C by the communication channel, but it is also possible to perform only transmission and reception to/from the terminal station 1 by the control channel.

Moreover, in the aforementioned embodiments, the data link layer and the physical layer of the wireless communication system are described, but it is naturally possible that each of the second base stations 3k, 3k+1, and 3k+2 has functions of the network layer and higher.

Further, the communication channel of each of the second base stations 3k, 3k+1, and 3k+2 may be used as any of a channel dedicated to an uplink, a channel dedicated to a downlink, and a channel for a bidirectional link in accordance with user's selection. In this case, it is possible to provide the most suitable wireless communication service according to a usage pattern of wireless communication by the user.

Furthermore, the first base station 2k and the second base station 3k may be integrated into one base station. In this case, if there are sharable components in the components including the antennas 201 and 221, these components may be shared.

Incidentally, in the aforementioned respective embodiments, the terminal station 1 may be a fixed terminal device used in a home or a office. Namely, the present invention can be also applied to FWA.

Moreover, it is also possible to provide control channels of the second base stations 3k to 3k+2, only perform a network control including charging and security of the terminal station 1 at least via the control channels of the first base stations 2k to 2k+2, and perform any other control such as channel assignment, incoming and outgoing calls, and the like via the control channels of the second base stations 3k to 3k+2.

### INDUSTRIAL AVAILABILITY

According to the present invention, it is possible to increase communication capacity at a low cost while making use of facilities of an existing wireless communication system.

1. A wireless communication system, comprising:
a first base station, connected to a terminal station via a first wireless communication line, for performing wireless communication on control information with the terminal station via a control channel; and
a second base station, connected to the terminal station via a second wireless communication line, for performing wireless communication on data with the terminal station via a communication channel based on the control information.

2. The wireless communication system according to claim 1,
wherein said first base station transmits synchronous control information on wireless communication to said second base station via the control channel, and
wherein said second base station receives the synchronous control information via the control channel of said first base station, and based on the received synchronous control information, performs wireless communication with the terminal station in synchronization with wireless communication of said first base station.

3. The wireless communication system according to claim 1, further comprising:
a service control station, connected to a backbone network to which said first base station is connected, for receiving the control information from said first base station, and based on the control information, managing the terminal station which uses both of said first base station and said second base station.

4. The wireless communication system according to claim 1, further comprising:
a service control station, connected to a backbone network to which said first base station is connected, for managing the terminal station which uses both of said first base station and said second base station,
wherein said second base station supplies information on charging for use of the communication channel of its own to said first base station,
wherein said first station transfers the information on charging from said second base station to said service control station, and
wherein said service control station performs charging management of the terminal station based on the information on charging.

5. The wireless communication system according to claim 1,
wherein said first base station controls said second base station based on the control information from the terminal station so that the communication channel is established.

6. The wireless communication system according to claim 1,
wherein said second base station is connected to a communication network whose speed is higher than that of a backbone network to which said first base station is connected.

7. The wireless communication system according to claim 6,
wherein said second base station uses the communication channel as a channel dedicated to a downlink to the terminal station, and
wherein said first base station establishes a communication channel dedicated to an uplink from the terminal station and performs wireless communication on data via the communication channel.

8. The wireless communication system according to claim 1,
wherein the communication channel of said second base station is used as any of a channel dedicated to an uplink, a channel dedicated to a downlink, and a channel dedicated to a bidirectional link in accordance with user's selection.

9. The wireless communication system according to claim 1, further comprising:
an area complementing base station for performing wireless communication on data with the terminal station located both inside a cell area of said first base station and outside a cell area of said second base station via a communication channel.

10. The wireless communication system according to claim 9,
wherein when the terminal station uses said area complementing base station, said first base station which governs a cell area in which the terminal station is located performs the wireless communication on the control information with the terminal station via the control channel.

11. The wireless communication system according to claim 1,
wherein said second base station is connected to a backbone network to which said first base station is connected.

12. The wireless communication system according to claim 1, further comprising:
a data communication line which connects said first base station and said second base station.

13. A base station, comprising:
a communicating part for performing wireless communication on control information with a terminal station via a control channel; and
a transmitting part for transmitting the control information to a different base station which performs wireless communication on data with the terminal station via a communication channel.

14. The base station according to claim 13,
wherein the base station transmits synchronous control information for allowing the different base station to perform wireless communication synchronously, to the different base station via the control channel.

15. The base station according to claim 13, further comprising:
a network communication part for transmitting information on charging for use of the communication channel of the different base station by the terminal station to a service control station which manages the terminal station.

16. The base station according to claim 13,
wherein said communicating part receives data via a communication channel dedicated to an uplink from the terminal station, and
wherein said transmitting part transmits control information for establishment of the communication channel as a channel dedicated to a downlink to the terminal station, to the different base station.

17. The base station according to claim 13,
wherein the base station operates in accordance with a control program stored in a rewritable memory.

18. A base station, comprising:
a receiving part for receiving control information from a different base station which performs wireless communication on control information with a terminal station via a control channel; and
a communicating part for establishing a communication channel based on the control information from the different base station and performing wireless communication on data with the terminal station via the communication channel.

19. The base station according to claim 18,
wherein said receiving part receives, via the control channel of the different base station, synchronous control information for wireless communication in synchronization with the different base station, and
wherein said communicating part performs wireless communication in synchronization with wireless communication of the different base station based on the synchronous control information received from said receiving part.

20. The base station according to claim 18,
wherein the base station is connected to a communication network whose speed is higher than that of a backbone network to which the different base station is connected.

21. The base station according to claim 20,
wherein the base station establishes the communication channel as a channel dedicated to a downlink to the terminal station.

22. The base station according to claim 18, further comprising:
a transmitting part for transmitting, via the different base station, information on charging for use of the communication channel to a service control station which is connected to a backbone network to which the different base station is connected, and manages the terminal station.

23. A terminal station, comprising:
a first radio, connected to a first base station via a first wireless communication line, for performing wireless communication on control information with the first base station via a control channel; and
a second radio, connected to a second base station via a second wireless communication line, for performing wireless communication on data with the second base station via a communication channel based on the control information.

24. The terminal station according to claim 23,
wherein said first radio transmits data via a communication channel dedicated to an uplink to the first base station, and
wherein said second radio receives data by using the communication channel as a channel dedicated to a downlink from the second base station.

25. A wireless communication method, comprising the steps of:
connecting a terminal station to a first base station via a first wireless communication line;
performing wireless communication on control information between the terminal station and the first base station via a control channel;
connecting the terminal station to a second base station via a second wireless communication line; and
performing wireless communication on data between the terminal station and the second base station via a communication channel, based on the control information.
